(19) United States
(12) Patent Application Publication
(10) Pub. No.: US 2019/0243698 A1
(43) Pub. Date: Aug. 8, 2019

(54) Electronic Control Unit for Flexible Replacement of Replaceable Components in a Vehicle

(71) Applicants: Robert Bosch GmbH, Stuttgart (DE); Robert Bosch Engineering and Business Solutions Private Limited, Bangalore (IN)

(72) Inventor: Adarsha Korlagundi Shridhara, Bangalore (IN)

(21) Appl. No.: 15/886,928

(22) Filed: Feb. 2, 2018

(51) Int. Cl. G06F 11/07; B60W 50/032

(52) U.S. Cl. CPC G06F 11/0724; B60W 2050/0005; B60W 50/032; G06F 11/0739

(57) ABSTRACT

An electronic control unit (ECU) (10) for flexible replacement of a plurality of replaceable components (14a, 14b, 14c) in a vehicle is disclosed. The ECU (10) comprises a plurality of memory units (18a, 18b, 18c) for storing operational instructions associated with the plurality of replaceable components (14a, 14b, 14c) and a processor (12) comprising a plurality of processing cores (12a, 12b, 12c). The processor (12) is adapted to identify the operational instructions associated to each of the plurality of replaceable components (14a, 14b, 14c), classify the operational instructions associated to each of the plurality of replaceable components (14a, 14b, 14c) into a plurality of groups (20a, 20b, 20c) and allocate each processing core, of the plurality of processing cores (12a, 12b, 12c), to each group for executing operational instructions associated to each replaceable component in each group.

### TECHNICAL FIELD

This disclosure is related to an electronic control unit (ECU) in a vehicle and more specifically to the ECU enabling flexible replacement of the replaceable components in the vehicle.

### BACKGROUND

Almost, every component in a vehicle functions based on operational instructions that are stored and executed in an electronic control unit (ECU). Operational instructions are a set of instructions that when executed in the ECU causes a component to function as desired. Every component in the vehicle is associated with a set of operational instructions. These operational instructions are stored in memory of the ECU. In one example, a fuel injector in the vehicle is associated with a set of operational instructions that when executed causes the fuel injector to inject fuel as desired based on the engine operating conditions. In another example, a throttle valve is associated with one set of operational instructions when executed by the processor causes the throttle valve opening or closing such that required air flows through the engine cylinder based on the engine operating condition. Similarly, there are many such components in the vehicle that operate based on corresponding set of operational instructions executed by the ECU.

The ECU comprises one or more processing cores that perform actual execution of the operational instructions. The operational instructions executed by each core is configured initially before manufacturing of the ECU. Once the ECU is manufactured, any updates or modifications in the operational instructions associated to any component cannot be performed without re-programming of the complete ECU which is a tedious process. Such problem is more clearly described with a scenario in the below paragraphs.

In one scenario, if a component in the vehicle is damaged, then the user of the vehicle is compelled to purchase the same component with the same brand and same make. This is because, if the user replaces the component with another component of a new brand then the component of the new brand is unable to accept operational instructions stored in the ECU due to mismatch of the brand. Hence the user is compelled to use the same component with the same brand and same make thereby limiting the user's choice from buying any equivalent component of a new brand found in the market.

Therefore, an ECU that allows flexible replacement of a replaceable component in the vehicle is required.

### BRIEF DESCRIPTION OF THE ACCOMPANYING DRAWINGS

FIG. 1 is a block diagram illustrating an electronic control unit (ECU) in a vehicle for flexible replacement of a replaceable component, in accordance with one embodiment of this disclosure; and

FIG. 2 is flowchart illustrating a method of flexible replacement of a replaceable component by an electronic control unit (ECU) in a vehicle, in accordance with one embodiment of this disclosure.

### DETAILED DESCRIPTION

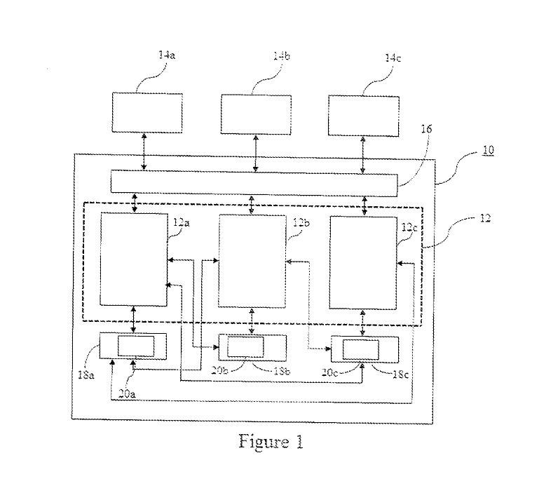

FIG. 1 is a block diagram illustrating an electronic control unit (ECU) (10) for flexible replacement of a replaceable component, in accordance with one embodiment of this disclosure.

For the purpose of explaining this disclosure, it is considered that the ECU (10) comprises a processor (12) which has three processing cores (12a, 12b, 12c). Each processing core (12a, 12b, 12c) is associated with a memory unit (18a, 18b, 18c) respectively. The processing cores (12a, 12b, 12c) can access the associated memory unit for obtaining the operational instruction and necessary data and resources required for executing the operational instructions. It should also be noted that one processing core, for example, processing core (12a) can also access the memory unit associated with the other two processing cores, processing core (12b) and processing core (12c) of the processor (12).

The ECU (10) also comprises of an input-output interface (16) for communicating information. The processing cores (12a, 12b, 12c) and other component of the vehicle, for example, (14a, 14b, 14c) communicate with each other through the input-output interface (16).

For the purpose of enabling flexible replacement of a replaceable component of the vehicle, the processor (12) is adapted to perform the following steps explained in the below paragraph.

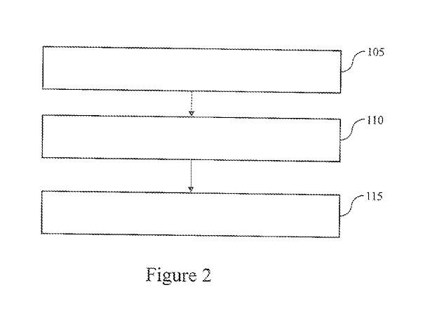

The processor (12) identifies operational instructions associated with each replaceable component of the plurality of replaceable components, for example, components (14a, 14b, 14c). This step is shown in (105) of FIG. 2.

Examples of the replaceable components include, but are not limited to, tyre, lambda sensor, battery, fuel injector and mirror. These components requires replacement due to one or more reasons such as damage due to accident, user not being satisfied with the component, the component not functioning as expected by the user or the component is worn-out and requires replacement. However, it should be noted that the replacement of the components are not limited to these reasons that are mentioned alone and there may be many other reasons for replacement of the component.

Operational instructions associated with each replaceable component includes a set of instructions that are executed by the processing cores (12a, 12b, 12c) for the functioning of the replaceable components, for example, components (14a, 14b, 14c). Usually, these operational instructions may be located at various memory locations. Also, in the prior arts, it should be noted that one or more processing cores may be involved in executing the set of instructions associated with one particular component and hence the operational instructions may be located at various memory locations.

In this disclosure, the processor (12) identifies such operational instructions associated with one replaceable component located at various memory units. Further the processor (12), organizes the operational instructions associated with the replaceable component to a particular memory unit by listing all the operational instructions associated with one replaceable component, for example component (14a) at one memory unit, for example, memory unit (18a).

The operational instructions associated with each replaceable component are identified and organized so that the operational instructions are executed sequentially by a single processing core, for example, processing core (12a) in a sequential manner.

In one embodiment, the process of identifying the operational instructions associated with each replaceable component may be performed based on a unique identity that correspond to all operation instructions associated with one replaceable component. Similarly, operational instructions associated with another replaceable component may correspond to another unique identity.

The processor (12) further classifies the operational instructions into a plurality of groups (20a, 20b, 20c) as illustrated in step (110) of FIG. 2. The maximum total number of groups (20a, 20b, 20c) into which the operational instructions can be classified is equal to total number of replaceable components in the vehicle. For example, if there are five replaceable components, then the operational instructions associated with each of the five replaceable components are classified into five groups. In other words, each group consists of operational instructions associated with one replaceable component.

Each group comprising operational instructions associated with one particular replaceable component is stored in one memory unit, for example memory unit (18a). This memory unit (18a) may be accessed by one or more processing cores (12a, 12b, 12c).

In some embodiments, the processor (12) classifies the operational instructions based on total number of processing cores present in the ECU (10). For example, if the ECU (10) comprises three processing cores (12a, 12b, 12c), then operational instructions associated with any three replaceable component, for example, the replaceable components (14a, 14b, 14c) are identified and classified into three groups (20a, 20b, 20c), each group being associated with one replaceable component. The any three replaceable components may be pre-specified by an original manufacturer.

The processor (12) may assign a unique identifier to a set of operational instructions associated to each replaceable component for classifying the set of operational instructions into various groups (20a, 20b, 20c). For example, the processor (12) may assign three unique identifiers for three sets of operational instructions associated to three different replaceable components (14a, 14b, 14c) for classifying the operational instructions, associated to three different replaceable components, into three groups (20a, 20b, 20c).

Upon classifying the operational instructions into groups (20a, 20b, 20c), the processor (12) allocates one processing core to each group, for example, processing core (12a) is allocated to first group (20a), processing core (12b) is allocated to second group (20b), and processing core (12c) is allocated to third group (20c). This is also shown in step (115) of FIG. 2. The processing cores (12a, 12b, 12c) allocated by the processor (12) executes the operational instructions comprised in that corresponding group for functioning of the associated replaceable component.

It should also be noted that, each processing core is associated with one replaceable component. Hence, each processing core can execute operational instructions associated with an associated replaceable component that has been allocated to the processing core by the processor (12).

The processor (12) also allocates an associated memory unit to the processing core. For example, the processing core (12a) is allocated the memory unit (18a), the processing core (12b) is allocated the memory unit (18b) and the processing core (12c) is allocated the memory unit (18c). The allocated memory unit stores the operational instructions associated with one particular group and hence the processing core can access the memory unit and therefore execute the operational instructions stored in the memory unit. Additionally, the processor (12) also allocates operating system resources to each processing core that are required for the execution of the operational instructions comprised in each group.

An exemplary scenario is explained in the below paragraphs for the purpose of clear understanding of the embodiment disclosed in the current disclosure. The exemplary scenario is explained with reference to FIG. 1.

For the purpose of exemplary description it is considered that the ECU (10) comprises three processing cores. First processing core (12a), second processing core (12b) and third processing core (12c). The first processing core (12a) is associated with the first memory unit (18a), the second processing core (12b) is associated with the second memory unit (18b) and the third processing core (12c) is associated with the third memory unit (18c).

It is considered that there are three replaceable components. First replaceable component (14a) being a lambda sensor, the second replaceable component (14b) being the front and back tyres and the third replaceable component (14c) being rear-view mirrors.

According to the current disclosure, the processor (12) identifies first set of operational instructions that are associated with the lambda sensor (14a), second set of operational instructions that are associated with the tyres (14b) and the third set of operational instructions that are associated with the rear-view mirrors (14c).

The first set, second set and the third set of operational instructions are identified and organized such that operational instructions present in each set can be executed sequentially. Further, each set of operational instructions are stored in a particular memory unit. In this example, the first set of operational instructions are stored in the first memory unit (18a), the second set of operational instructions are stored in the second memory unit (18b) and the third set of operational instructions are stored in the third memory unit (18c).

The processor (12) then classifies the operational instructions associated with lambda sensor (14a), tyres (14b) and the rear-view mirrors (14c) into three groups (20a, 20b, 20c), namely first group (20a), second group (20b) and third group (20c). The first group (20a) is associated with the lambda sensor (14a), the second group (20b) is associated with the tyres (14b) and the third group (20c) is associated with the rear-view mirrors (14c). In one embodiment, for the purpose of classification, the processor (12) may create a unique identifier and assign the created unique identifier to the first set of operational instructions. Similarly, the processor (12) may create second unique identifier and assign the second unique identifier to the second set operational instructions. Similarly, a third unique identifier is created and assigned to the third set of operational instructions.

Further, upon creating three groups (20a, 20b, 20c), the processor (12) allocates one processing core to each group. In this example, the first processing core (12a) is allocated to the first group so that the first processing core (12a) can execute the first set of operational instructions that are associated with the lambda sensor (14a). The processor (12) also enables the first processing core (12a) to access the first memory unit (18a) where the first set of operational instructions are stored. Similarly, the second processing core (12b) is allocated to the second group so that the second processing core (12b) can execute the second set of operational instructions that are associated with the tyres (14b). The second set of operational instructions are stored in the second memory unit (18b) and the second processing core (12b) can access the second memory unit (18b). The third processing core (12c) is allocated to the third group for executing the third set of operational instructions associated with the rear-view mirrors (14c). The third processing core (12c) is enabled to access the third memory unit (18c) where the third set of operational instructions are stored.

Additionally the processor (12) also allocates operating system resources used for executing the operational instructions by the first processing core (12a), second processing core (12b) and the third processing core (12c). The complete process of grouping operational instructions associated with replaceable components and allocating each processing core for executing operational instructions associated with a particular replaceable component is also referred to as partitioning of a multi-core ECU (10).

It is considered that the lambda sensor of Brand-1 is replaced with a new lambda sensor of Brand-2 by a user. While the user purchases the lambda sensor of Brand-2, the user also obtains new operational instructions required for functioning of the lambda sensor of Brand-2. In such cases, the user can easily re-configure only the first processing core (12a) with the new operational instructions so that the first processing core (12a) will now execute the new operational instructions associated with the lambda sensor of Brand-2. Reconfiguring the first processing core (12a) includes erasing an existing operational instructions associated with the lambda sensor of Brand-1 and replacing the existing operational instructions with new operational instructions required for functioning of the lambda sensor of Brand-2. In other words, only the first processing core (12a) is flashed with the new operational instructions.

In the above example, by re-configuring only the first processing core (12a) where operational instructions associated with the lambda sensor is executed, the second processing core (12b) and the third processing core (12c) are undisturbed. Therefore by grouping the operational instructions such that each processing core is executing operational instructions associated with one replaceable component, the whole ECU (10) need not be re-configured when one particular component of a specific brand is replaced by another component of a different brand. Therefore the ECU (10) disclosed in the current disclosure enables for flexible replacement of replaceable components by grouping the processing cores based on the replaceable components and further without having to reconfigure the whole ECU (10) in case if one component is being replaced.

It must be understood that the embodiments explained in the above detailed description is only illustrative and does not limit the scope of this disclosure. Any modification in the embodiments with regard to the process of identifying the operational instructions, the process of classifying the operational instructions into a plurality of groups are envisaged and form a part of this disclosure.

1. An electronic control unit in a vehicle, the electronic control unit comprising:
a plurality of memory units configured to store operational instructions associated with a plurality of replaceable components; and
a processor comprising a plurality of processing cores, the processor being configured to:
identify the operational instructions associated with each of the plurality of replaceable components;
classify the operational instructions associated with each of the plurality of replaceable components into a plurality of groups; and
allocate each processing core, of the plurality of processing cores to a respective group of the plurality of groups; and
execute the operational instructions associated to each of the plurality of replaceable components in each respective group of the plurality of groups using the allocated processing core of the plurality of processing cores.

2. The electronic control unit as claimed in claim 1, wherein the operational instructions are executed to operate of each of the plurality of replaceable components.

3. The electronic control unit as claimed in claim 1, wherein the plurality of memory units are associated to the plurality of processing cores.

4. The electronic control unit as claimed in claim 1, wherein a number of groups in the plurality of groups is equal to a number of replaceable components in the plurality of replaceable components.

5. The electronic control unit as claimed in claim 1, wherein each group of the plurality of groups is associated to the operational instructions that correspond to each replaceable component of the plurality of replaceable components.

6. The electronic control unit as claimed in claim 1, wherein the processor is further configured to:
allocate the memory units and operating system resources to the plurality of groups for the execution of the operational instructions associated to each of the plurality of replaceable components.

7. A method of replacement of a plurality of replaceable components, the method comprising:
identifying operational instructions associated with each of the plurality of replaceable components;
classifying the operational instructions associated with each of the plurality of replaceable components into a plurality of groups;
allocating each processing core of a plurality of processing cores, to a respective group of the plurality of groups; and
executing the operational instructions associated to each of the plurality of replaceable components in each respective group of the plurality of groups using the allocated processing core of the plurality of processing cores.

8. The method as claimed in claim 7, further comprising:
allocating memory units and operating system resources to the plurality of groups for the executing of the operational instructions associated to each of the plurality of replaceable components.

9. The method as claimed in claim 7, wherein the classifying of the operational instructions into the plurality of groups is based on the plurality of replaceable components.
